(19) United States
(12) Patent Application Publication
(10) Pub. No.: US 2005/0161480 A1
(43) Pub. Date: Jul. 28, 2005

(54) Seat mounted storage unit for a motor vehicle

(76) Inventor: Robert S. Tirey, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/763,891

(22) Filed: Jan. 23, 2004

(51) Int. Cl. B60R 7/00

(52) U.S. Cl. 224/275

(57) ABSTRACT

The invention relates to a storage unit for a motor vehicle, such as a truck cab. The storage unit has a seat back and a cabinet attached to the rear of the seat back at a forward mounting section of the seat back.

### BACKGROUND OF THE INVENTION

1. Field of the Invention

The present invention relates to storage units for motor vehicles.

2. Description of the Prior Art

Storage space is at a premium in many types of motor vehicles, especially short cab trucks. In a truck cab like a short cab truck, the driver often lives in the cab over a period of days or weeks. The driver sleeps in a bed or bunk located in the back of the cab behind the seat. When resting in bed, the driver has few places to store items such as eyeglasses, cups, reading materials, tissues, and the like. Due to the shortage of space, there are few places to store clothes and other personal items in the cab.

Many motor vehicles have seats with seat backs that slant toward the front of the vehicle to provide lumbar support for the occupant.. In the rear of this area of the seat, a net or narrow flexible pocket stows some flatter items. In a passenger car or light truck, this space is usually reserved for the back seat passengers' leg room. Therefore, the pocket is not designed to provide much more than flat or two-dimensional storage. Other seat back storage designs are provided within a recess in the body of the seat itself to avoid interfering with this leg room space.

In a truck cab this space is wasted. A truck cab does not need to provide the leg room.

Therefore, it is one object of the invention to increase the storage in a motor vehicle. Another object of the invention is removably install storage units in the vehicle. Another object of the invention is to use the space located in the lumbar area of the seat and behind the seat for storage. Still another object of the invention is to store items in a three-dimensional manner.

### SUMMARY OF THE INVENTION

According to the invention, there is provided a storage unit for a motor vehicle, such as a truck cab. The storage unit has a seat back and a cabinet. The seat back has a forward slanting section, an upper section, and a rear. The cabinet has a cabinet top and an opposite cabinet base. Cabinet sidewalls are located between the cabinet top and the cabinet base, and an outer wall is located between the cabinet sidewalls. A cabinet mounting mechanism attaches the cabinet to the rear of the seat back at the forward slanting section.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of one embodiment of the invention;

FIG. 2 is a perspective view of a cabinet in one embodiment of the invention;

FIG. 3 is a perspective view of a seat back in one embodiment of the invention;

FIG. 4 is a perspective view of one embodiment of the invention; and

FIG. 5 is a side view of one embodiment of the invention.

### DETAILED DESCRIPTION OF THE INVENTION

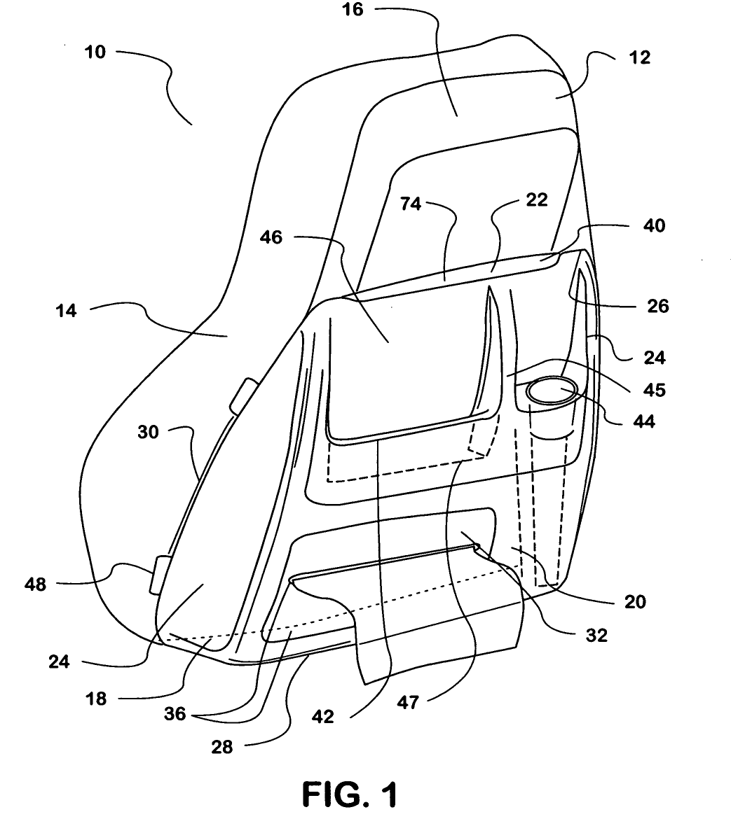

Turning now to the figures where like reference numerals refer to like objects, FIG. 1 shows storage unit 10 for a motor vehicle with attached seat 11. Seat 11 has seat back 12 attached to seat bottom 13. Cabinet 18 attaches to seat back 12 of seat 11. Seat back 12 has forward slanting section 14 below upper section 16.

Cabinet 18 has cabinet top 26 and opposite cabinet base 28 with cabinet sidewalls 24 therebetween. Cabinet 18 also has outer wall 20 and preferably inner wall 22 adjacent forward slanting section 14 of seat back 12, with cabinet sidewalls 24 therebetween. Cabinet base 28 can be wider than cabinet top 26. Therefore, cabinet sidewalls 24 can have slanted edge 30 opposite outer wall 20.

Cabinet 18 preferably has cabinet interior 38 defined by outer 20 and inner 22 walls, sidewalls 24 and cabinet base 28. Cabinet interior 38 has a number of compartments defined by vertical 46 and horizontal 47 partitions. A different arrangement of vertical and horizontal partitions can define different types of storage spaces for cabinets used at the rear of the other seat back. If desired, partitions can be removable and are arranged by sliding within slots in inner 22 and outer 20 walls and/or sidewalls 24.

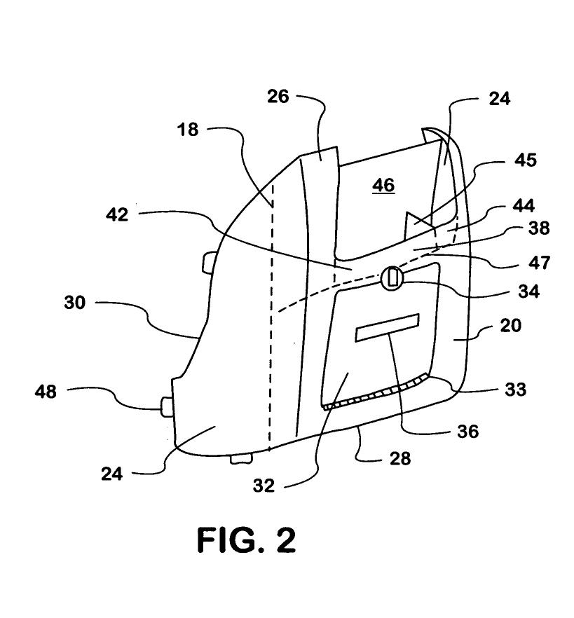

Storage compartment 40 as shown in cabinet 18, for example, is defined in cabinet interior 38 by cabinet sidewalls 24, vertical partition 46, horizontal partition 47 and mouth 74 at cabinet top 26 and can be used for storing magazines or a cutting board. Part of storage compartment 40 is formed with inner wall 22 (FIG. 1) or alternatively with seat back 12 itself if there is no inner wall 22 (FIG. 2). Intersecting vertical partitions 45, 46, horizontal partition 47 and outer wall 20 define storage compartment 42 which includes a narrow, partially enclosed shelf for storing eyeglasses, a wallet or other items. Vertical partition 46, cabinet base 28, outer wall 20 and sidewall 24 define storage compartment 44 which can hold a flashlight. Alternatively, storage compartment 44 can extend to horizontal partition 47 (FIG. 2).

Outer wall 20 has door 32 which encloses tissue compartment 43. Door 32 closes with locking mechanism 34, such as a latch, a knob, and the like. Door 32 opens outwardly and downwardly and movably attaches to cabinet 18 with movable device 33, such as an extension arm, a hinge, and the like. Door 32 can have dispensing slot 36 for dispensing tissues or paper towels. Tissue compartment 43 is defined by horizontal partition 47, cabinet sidewall 24, outer wall 20, door 32 and vertical partition 45. A tissue box or paper towel can fit within tissue compartment 43 with a tissue or towel extending through dispensing slot 36. For paper towels, a spring loaded rod may extend from cabinet sidewall 24 to vertical partition 45. Alternatively, door 32 may serve as a table.

Turning to the embodiment shown in FIG. 4, cabinet 50 has handle 52 attached to cabinet top 54 and exterior compartments, such as pockets 56, 58, attached to outer wall 62. Pocket 56 stores small items, while pocket 58 stores tissues or other items. Cabinet 50 may also have cabinet interior 60 for additional storage that is accessed either through an opening in cabinet top 54 or along outer wall 62 at or near cabinet sidewalls 66. Zipper 59 or clasp closes the opening. Cabinet interior 60 is defined by cabinet sidewalls 66, cabinet top 54, cabinet base 55 and opposite cabinet outer 62 and inner 64 walls. Vertical and horizontal partitions can divide cabinet interior 60 into compartments, if desired.

Cabinets 18 and 50 attach to rear 17 of seat back 12 with cabinet mounting mechanism 72. In the embodiment shown in FIG. 1, mounting mechanism 72 includes tab 48 extending outwardly from sidewall 24, cabinet base 28 or inner wall 22 of cabinet 18. Preferably, cabinet 18 fastens to seat frame 76 using a plurality of tabs 48 welded to the seat frame or with fasteners extending through tabs 48 into the seat frame (not shown). Alternatively, sidewalls 24 themselves can directly attach to seat frame (not shown).

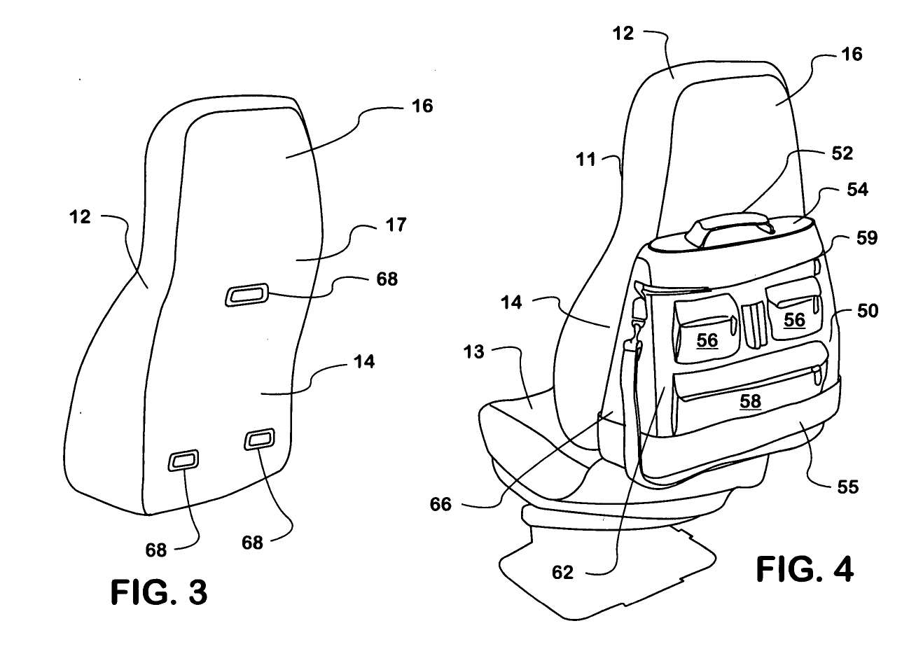

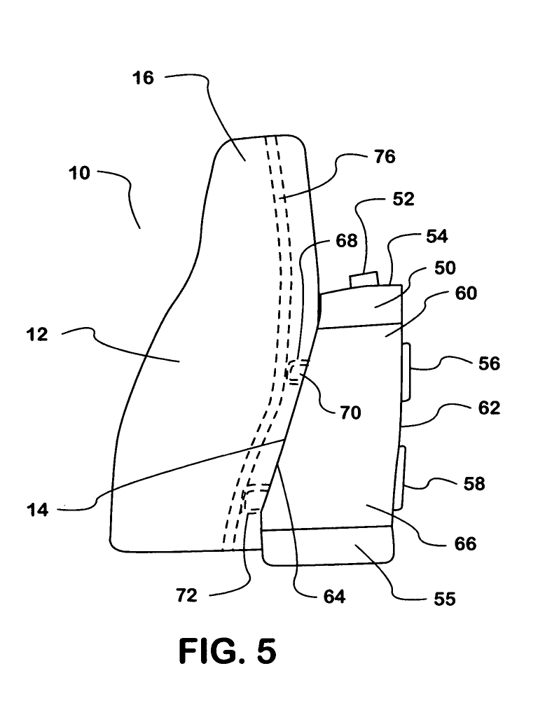

In the embodiment shown in FIGS. 3-5, cabinet 50 releasably mounts to rear 17 of seat back 12 with cabinet mounting mechanism 72 to form a modular storage system. Cabinet mounting mechanism 72 matingly engages and locks cabinet 50 to rear 17 of seat back 12. Preferably, cabinet mounting mechanism 72 includes receiver 68 in seat back 12 and tongue 70 extending outwardly from cabinet 50. Receiver 68 matingly engages tongue 70 which extends outwardly from inner wall 64. Alternatively, a tongue can extend outwardly from the rear of seat back 12 to matingly engage a receiver in cabinet 50 (not shown). Seat frame 76, such as a support column, is preferably mounted to or integral with the receiver or tongue, depending on the embodiment. Preferably cabinet 50 releasably engages seat back 12 with a plurality of mounting mechanisms 72.

An increase in available storage space is one advantage to the storage unit of the invention. Another advantage to the storage unit of the invention is there is no decrease in comfort for the seat's occupant. Because the storage unit is outside of the seat back, there is no decreased padding in the seat back. Another advantage of the invention is the change of storage space in the seat back from flat two-dimensional storage to a three dimension storage without reducing space within the vehicle.

The modular storage system provides the further advantage of allowing the user to pack personal items at home, carry the packed cabinet into the vehicle and storing the items within the packed cabinet in the vehicle. The modular storage system also readily allows the user to change or replace the cabinet as needed.

While the invention is shown in only one of its forms, it is not thus limited but is susceptible to various changes and modifications without departing from the spirit and scope of the invention.

1. A storage unit for a motor vehicle comprising:
a seat back comprising a forward slanting section, an upper section, and a rear;
a cabinet comprising a cabinet top, an opposite cabinet base, cabinet sidewalls between the cabinet top and the cabinet base, and an outer wall located between the cabinet sidewalls; and
a cabinet mounting mechanism attaching the cabinet to the rear of the seat back at the forward slanting section.

2. A storage unit for a motor vehicle of claim 1, further comprising:
an inner wall opposite the outer wall and between the cabinet sidewalls and located adjacent the rear of the seat back at the forward slanting section.

3. A storage unit for a motor vehicle of claim 2, further comprising:
a cabinet interior defined by the cabinet top, the cabinet base, the cabinet sidewalls, the outer wall and the inner wall.

4. A storage unit for a motor vehicle of claim 3, further comprising:
a seat frame in the seat back; and
wherein the cabinet mounting mechanism attaches the cabinet to the seat frame.

5. A storage unit for a motor vehicle of claim 4, further comprising:
partitions within the cabinet interior.

6. A storage unit for a motor vehicle of claim 5, wherein the mounting mechanism further comprises:
a tab extending outwardly from the cabinet and engaging the seat frame.

7. A storage unit for a motor vehicle of claim 6, further comprising:
exterior compartments attaching to the outer wall.

8. A storage unit for a motor vehicle of claim 6, further comprising:
a seat bottom attached to the seat back.

9. A storage unit for a motor vehicle of claim 4, wherein the cabinet mounting mechanism releasably attaches the cabinet to the seat frame.

10. A storage unit for a motor vehicle of claim 9, wherein the cabinet mounting mechanism further comprises:
a receiver; and
a tongue extending outwardly to matingly engaging the receiver.

11. A storage unit for a motor vehicle of claim 10, further comprising:
partitions within the cabinet interior.

12. A storage unit for a motor vehicle of claim 11, wherein the receiver attaches to the seat frame and the tongue extends outwardly from the cabinet.

13. A storage unit for a motor vehicle of claim 11, further comprising:
exterior compartments attaching to the outer wall.

14. A storage unit for a motor vehicle of claim 12, further comprising:
a seat bottom attached to the seat back.
